(19) United States
(12) Patent Application Publication
(10) Pub. No.: US 2011/0091057 A1
(43) Pub. Date: Apr. 21, 2011

(54) EYEGLASSES WITH A PLANAR ARRAY OF MICROPHONES FOR ASSISTING HEARING

(75) Inventor: RENE MARTINUS MARIA DERKX, EINDHOVEN (NL)

(73) Assignee: NXP B.V., Eindhoven (NL)

(21) Appl. No.: 12/581,051

(22) Filed: Oct. 16, 2009

(51) Int. Cl. H04R 25/00

(52) U.S. Cl. 381/313; 381/327

(57) ABSTRACT

An apparatus implements directional sound detection. The apparatus includes a portable hearing aid device, a plurality of sound detectors, and electronic circuitry. The sound detectors are coupled to the portable hearing aid device. The sound detectors are arranged in a substantially planar array which is located in approximately a two-dimensional plane which extends through both a listener position and a sound generator position. The electronic circuitry is electronically coupled to the plurality of sound detectors. The electronic circuitry generates a reproduced sound signal based on sound signals from at least a subset of the plurality of sound detectors. The subset includes at least two sound detectors in a one-dimensional line and at least one sound detector located within the two-dimensional plane other than along the one-dimensional line.

There are many people around the world who deal with hearing loss. In some cases, hearing aid devices can be used to help people improve their hearing despite natural losses in high-frequency discrimination. Hearing aid devices typically amplify sounds so that the user can hear the sounds more easily. Unfortunately, many conventional hearing aid devices amplify all sounds, including ambient noise, making it difficult to distinguish an intended source (e.g., a person's voice) from the rest of the ambient noise.

One conventional solution to the problem of amplified ambient noise is the use of in-ear digital hearing aids. Such hearing aids include multiple microphones that provide tunable directionality so that a hearing aid has a preferred direction of sensitivity, usually tuned to be forward facing. In this way, the hearing aid increases the sound from the conversation ahead of the user, without increasing all of the background noise.

Another conventional solution for this problem of amplified ambient noise is implemented in eyeglasses which can be worn by the user. The eyeglasses incorporate hearing aid devices and, hence, are sometimes referred to as “hearing-glasses.” One company that manufactures such hearing-glasses is Varibel (www.varibel.nl) of Brussels, Belgium. The hearing-glasses manufactured by Varibel use an end-fire array of microphones which are mounted on the stems of the glasses. The end-fire array of microphones has an increased sensitivity to sounds waves which originate from a source that is approximately in line with the axis of the array (i.e., in front of the user).

With the hearing-glasses from Varibel, the sound from the front is amplified and the diffuse noise coming from other directions is reduced relative to the intended sound. The technical term that is used to measure the diffuse noise reduction is called the directivity index (DI), which equals:

$$DI = 10 {log}_{10} ( Q ) , where$$

$$Q = \frac{4 π {E}^{2} ( π / 2 , 0 )}{{\int }_{φ = 0}^{2 π} {\int }_{θ = 0}^{π} {E}^{2} ( θ , φ ) sin θ d θ d φ}$$

in which φ,θ are the standard spherical coordinate system parameters (azimuth and elevation, respectively), E is the directional response, and the look direction is given by θ=π/2 and φ=0. In a specific example using four microphones in an end-fire array configuration, the hearing-glasses of Varibel use first- and second-order superdirectional processing to obtain a weighted directivity index of 8.2 dB.

Other conventional hearing-glasses use a broad-side array of microphones which are mounted to the front portion of the glasses. The broad-side array of microphones has an increased sensitivity to sound waves that originate from a source that is approximately perpendicular to the axis of the array. However, for wavelengths larger than the spacing of the microphone array, the directivity index is poor for broad-side arrays. Therefore, the end-fire array is typically preferred for such wavelengths. The specific characteristics of the detection beam patterns of various end-fire and broad-side arrays depends on several factors, including the sensitivity of the individual microphones and the spacing between the microphones. Hereafter, only distances which are smaller than the wavelengths of interest are considered for the spacing between the microphones.

Whether an end-fire or a broad-side array is used on the hearing-glasses, the directivity of the array of microphones is typically substantially forward of the person wearing the glasses. While these conventional array configurations help increase the hearing sensitivity of the user in the general direction that the user may be looking, end-fire and broad-side array configurations are not optimal to suppress noise from an interference noise source that is positioned close to the angle of the intended sound generator. Specifically, with an end-fire array, only the directivity index (reduction for diffuse noise coming from all directions) is improved. The directivity index can also be improved for a broad-side array. However, this improvement is lower compared with the improvement for an end-fire array. Furthermore, at least three microphones in a line-array and second- or higher-order beamformers are required to obtain this improvement. However, second- and higher-order beamformers are difficult to realize in practice. Also, it is difficult for such broad-side arrays to suppress noise from an interference source that is positioned close to the angle of the intended sound generator. As one example, the hearing aid user may have difficulty distinguishing between the sound from a person with whom the user is talking (and facing) and the noise from another person that is talking near the person with whom the user is talking. In other words, it is difficult to suppress noises that originate within the detection beam pattern of the conventional end-fire and broad-side arrays.

Embodiments of an apparatus are described. In one embodiment, the apparatus implements directional sound detection. An embodiment of the apparatus includes a portable hearing aid device, a plurality of sound detectors, and electronic circuitry. The sound detectors are coupled to the portable hearing aid device. The sound detectors are arranged in a substantially planar array which is located in approximately a two-dimensional plane which extends through both a listener position and a sound generator position. The electronic circuitry is electronically coupled to the plurality of sound detectors. The electronic circuitry generates a reproduced sound signal based on sound signals from at least a subset of the plurality of sound detectors. The subset includes at least two sound detectors in a one-dimensional line and at least one sound detector located within the two-dimensional plane other than along the one-dimensional line. Other embodiments of the apparatus are also described.

Embodiments of a pair of hearing glasses are also described. In one embodiment, the hearing glasses include a pair of optical elements, a frame, and a hearing aid device. The optical elements are conventional lenses used in a pair of eyeglasses. The frame includes a front portion and two stems. The front portion holds the pair of optical elements. The stems hold the frame in a position relative to a user's head. The hearing aid device is coupled to the frame. In one embodiment, the hearing aid device includes a planar array of sound detectors and electronic circuitry. The planar array includes at least three sound detectors, of which at least one sound detector is coupled to the front portion of the frame, and at least one sound detector is coupled to one of the stems. The electronic circuitry is electronically coupled to the planar array of sound detectors to generate a reproduced sound signal based on sound signals from the planar array of sound detectors. Other embodiments of the hearing glasses are also described.

Embodiments of a method are also described. In one embodiment, the method is a method for controlling directivity of a hearing aid device. An embodiment of the method includes detecting sound waves at a plurality of sound detectors coupled to a portable hearing aid device. The sound detectors are arranged in a substantially planar array which is located in approximately a two-dimensional plane which extends through both a listener position and a sound generator position. The method also includes generating a reproduced sound signal based on sound signals from at least a subset of the plurality of sound detectors. The subset includes at least two sound detectors in a one-dimensional line and at least one sound detector located within the two-dimensional plane other than along the one-dimensional line. The method also includes generating an audible sound representative of the reproduced sound signal and communicating the audible sound to a user of the portable hearing aid device. Other embodiments of the method are also described.

Other aspects and advantages of embodiments of the present invention will become apparent from the following detailed description, taken in conjunction with the accompanying drawings, illustrated by way of example of the principles of the invention.

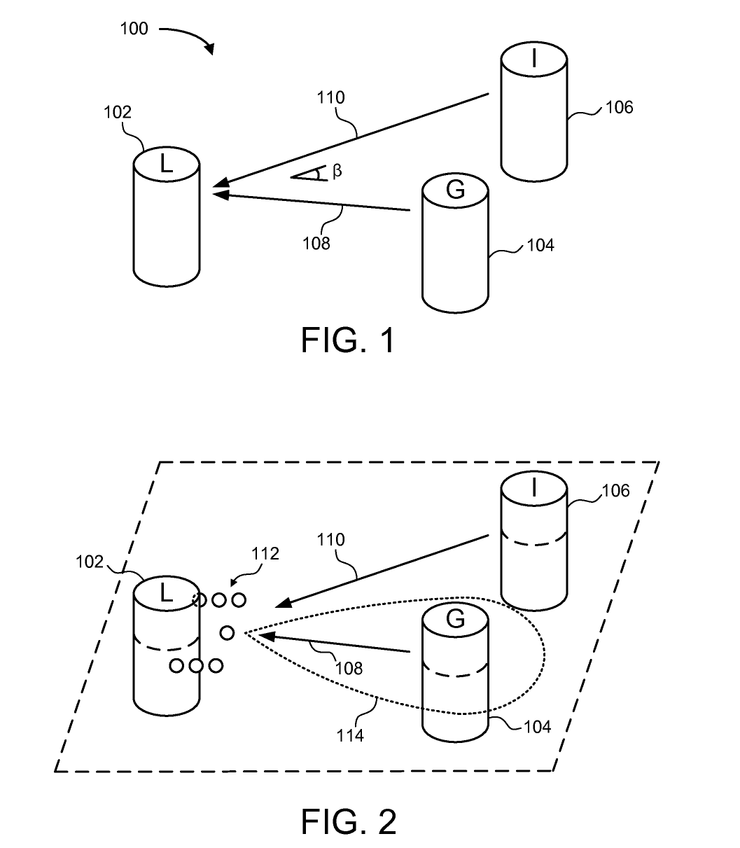

FIG. 1 depicts a schematic diagram of one embodiment of a listening arrangement.

FIG. 2 depicts a schematic diagram of one embodiment of a planar array of sound detectors for use in the listening arrangement of FIG. 1.

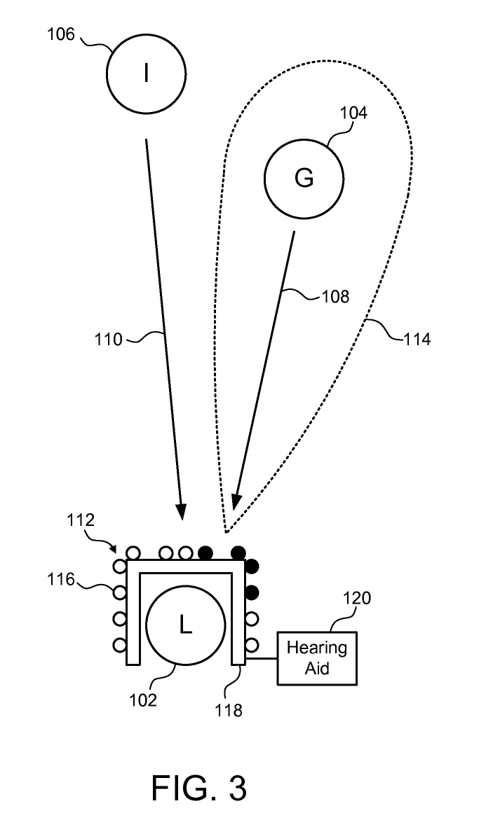

FIG. 3 depicts a schematic diagram of another embodiment of a planar array of sound detectors for use in the listening arrangement of FIG. 1.

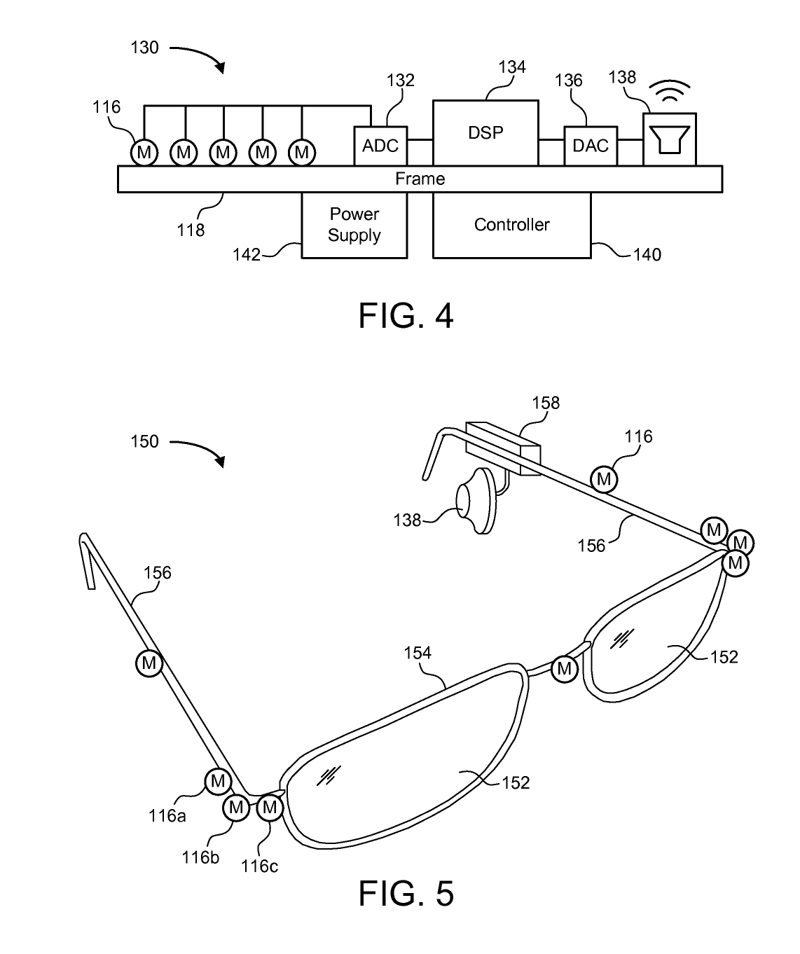

FIG. 4 depicts a schematic block diagram of one embodiment of an apparatus for directional sound detection.

FIG. 5 depicts a diagram of one embodiment of a pair of hearing glasses with a planar array of sound detectors coupled to the frame of the hearing glasses.

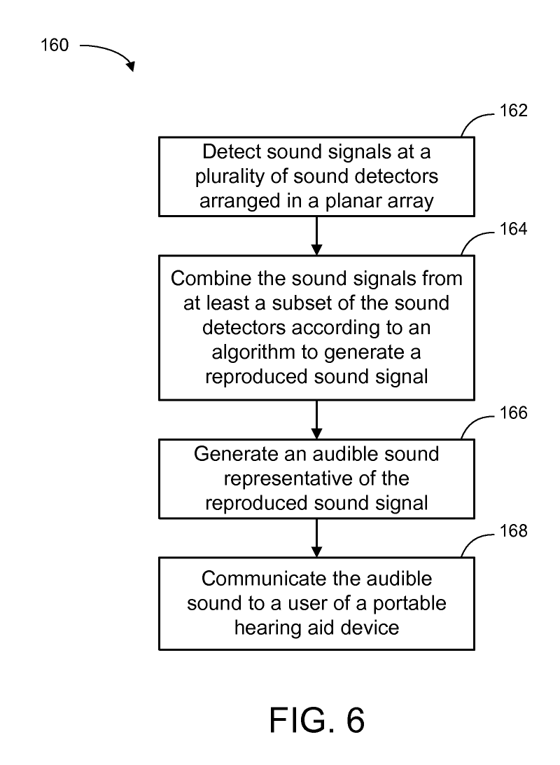

FIG. 6 depicts a flow chart diagram of one embodiment of a method for controlling directivity of a hearing aid device.

Throughout the description, similar reference numbers may be used to identify similar elements.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments function to construct a steerable beam-pattern where a null is placed toward the angle of the point-interferer while maintaining a unity response to the listening angle and still having sufficient diffuse noise reduction. The type of a null-steering scheme allows the rejection of noise from an interferer near the listening angle. Also, at least some embodiments implement hearing-glasses with a planar array of microphones which provides a superdirectional beam-pattern synthesis with the rejection of noise from an interferer, even if the interferer is close to the listening angle.

FIG. 1 depicts a schematic diagram of one embodiment of a listening arrangement 100. The illustrated listening arrangement 100 depicts the positions of various participants in a conversation or other listening environment. In particular, the illustrated listening arrangement 100 includes a listener 102 (designated as “L”), a sound generator 104 (designated as “G”), and an interference sound source 106 (designated as “I”). For convenience, the listener 102, sound generator 104, and interference sound source 106 are each described herein as humans who generate or listen to audible sounds (e.g., during a conversation). However, in some embodiments, the listener 102, sound generator 104, and/or interference noise source 106 may be another type of animal or machine capable of generating audible sounds.

As a matter of convention for the description herein, the listener 102 is regarded as a person who is trying to listen to the sounds (e.g., speech) generated by the sound generator 104. The sounds generated by the sound generator 104 travel through space as sound waves 108, depicted by the arrow between the sound generator 104 and the listener 102. Also, the interference sound source 106 may generate separate sounds which are designated as interference noise because the listener 102 deems such sounds as interfering with the sounds from the sound generator 104. The sounds generated by the interference sound source 106 propagate through space as sound waves 110, depicted by the arrow between the interference sound source 106 and the listener 102. The angle, β, between the sound generator 104 and the interference sound source 106, relative to the listener 102, is referred to herein as the angular difference between the sound generator 104 and the interference sound source 106.

FIG. 2 depicts a schematic diagram of one embodiment of a planar array 112 of sound detectors for use in the listening arrangement 100 of FIG. 1. In one embodiment, the planar array 112 of sound detectors is incorporated with a hearing aid device so that the listener 102 can more easily hear and understand the sound generated by the sound generator 104. In one embodiment, the hearing aid device is a portable hearing aid device.

For reference, the sound detectors are arranged in a substantially planar array 112 which is located in approximately a two-dimensional (2D) plane (depicted by the dashed lines forming a parallelogram in FIG. 2). In the depicted embodiment, the two-dimensional plane extends through the positions of the listener 102 and the sound generator 104. The two-dimensional plane also extends through the position of the interference sound source 106. Although the planar array 112 is referred to herein as being within the two-dimensional plane, other embodiments may include additional sound detectors that are outside of the two-dimensional plane. Hence, the array of sound detectors is not necessarily limited to a two-dimensional plane, so long as the sound detectors are arranged in some form of multi-dimensional configuration, rather than substantially in a line such as an end-fire or broad-side array.

Electronic circuitry (refer to FIG. 4) manipulates the sound signals generated by some or all of the sound detectors in the planar array 112 in order to generate a reproduced sound signal which allows the listener 102 to more easily hear and understand the sounds from the sound generator 104. In circumstances where sound signals from less than all of the sound detectors are used to generate the reproduced sound signal, the operative sound detectors nevertheless should be arranged in a substantially planar, two-dimensional pattern. Thus, at least two sound detectors may be a one-dimensional line, and at least one other sound detector is located within the two-dimensional plane other than along the one-dimensional line.

In general, the electronic circuitry combines the sound signals to generate substantially a unity response 114 at a listening angle toward the position of the sound generator 104. In general, a unity response at a certain listening angle means that the response at this angle is equal to the response of a single omnidirectional microphone at this angle. The electronic circuitry also generates substantially a null response at an interference angle toward the position of the interference sound source 106. A null response at a certain listening angle means that the response is substantially lower (in theory, infinitely lower) than the response of a single omnidirectional microphone at this angle.

In some embodiments, a subset of the sound detectors, rather than all of the sound detectors in the planar array 112, may be used in order to alleviate sensor noise problems in the construction of superdirectional responses. As one example, the electronic circuitry uses the sound signals from a subset of at least three sound detectors (e.g., the sound detectors 116a, 116b, and 116c shown in FIG. 5). More specifically, the electronic circuitry combines the sound signals to generate the reproduced sound signal based on a first-order steerable superdirectional response.

By using a circular array of at least three omnidirectional sound detectors, or sensors, in a planar geometry and the application of signal processing techniques, it is possible to construct a first-order superdirectional response that can be steered with its main-lobe to any desired azimuthal angle and can be adjusted to have any first-order directivity pattern (cardioid, hypercardioid, etc.). This construction is performed via so-called zeroeth- and first-order eigenbeams. For wavelengths larger than the size of the array, and assuming that there is no sensor-noise, the responses of the eigenbeams are frequency invariant and ideally equal to:

Eₘ=1

E_{d}⁰(θ,φ)=cos(φ)sin(θ)

E_{d}^{π/2}(θ,φ)=cos(φ−π/2)sin(θ)

in which φ,θ are the standard spherical coordinate angles: elevation and azimuth.

The zeroeth-order eigenbeam Eₘ represents the monopole response, while the first-order eigenbeams E_{d}⁰(θ,φ) and E_{d}^{π/2}(θ,φ) represent the orthogonal dipole responses.

The dipole response can be steered to any angle, φₛ, by means of a weighted combination of the orthogonal dipole pair:

E_{d}^{φ}^{ₛ}(θ,φ)=cos(φₛ)E_{d}⁰(θ,φ)+sin(φₛ)E_{d}^{π/2}(θ,φ)

with 0≦φₛ≦2π as the steering angle.

The steered and scaled superdirectional microphone response can be constructed via:

$$\begin{matrix}E ( θ , φ ) = S [ α {E}_{m} + ( 1 - α ) {E}_{d}^{{ϕ}_{s}} ( θ , φ ) ] \\ = S [ α + ( 1 - α ) cos ( φ - {ϕ}_{s} ) sin ( θ ) ]\end{matrix}$$

with α≦1 as the parameter for controlling the directional pattern of the first-order response, and S as an arbitrary scaling factor (which can also have a negative value).

It should be noted that the foregoing equations may be based on an assumption that there is a unity response of the superdirectional microphone for a desired source coming from an arbitrary azimuthal angle, φ, and for an elevation angle of θ=π/2.

In some embodiments, the directivity factor, Q, is optimized under the constraints that a unity response is obtained at the listening angle, \tilde{φ}ₛ, and a null is obtained at the interference angle, φₙ. The optimal pattern synthesis for a first-order superdirectional response can be constructed using:

$$S = \frac{1}{α + ( 1 - α ) cos ( {\tilde{ϕ}}_{s} - {ϕ}_{s} )} , where$$

$$α = \frac{cos ( {ϕ}_{n} - {ϕ}_{s} )}{cos ( {ϕ}_{n} - {ϕ}_{s} ) - 1} , and$$

$${ϕ}_{s} = {ϕ}_{n} - 2 arctan [ \frac{1 - cos ( {ϕ}_{n} - {\tilde{ϕ}}_{s} ) \pm \sqrt{A}}{4 sin ( {ϕ}_{n} - {\tilde{ϕ}}_{s} )} ] , with$$

$$A = {cos}^{2} ( {\tilde{ϕ}}_{s} - {ϕ}_{n} ) + 16 {sin}^{2} ( {\tilde{ϕ}}_{s} - {ϕ}_{n} ) - 2 cos ( {\tilde{ϕ}}_{s} - {ϕ}_{n} ) + 1 - 64 cos ( {\tilde{ϕ}}_{s} ) cos ( {ϕ}_{n} ) sin ( {\tilde{ϕ}}_{s} ) sin ( {ϕ}_{n} )$$

As another example, the electronic circuitry uses the sound signals from a subset of at least four sound detectors. In this example, the electronic circuitry combines the sound signals to generate the reproduced sound signal based on a second-order steerable superdirectional response. However, it should be noted that second-order beam patterns may be difficult to construct in practice, especially for low-frequencies, where the wavelength is much longer than the array size. Such difficulties are due, at least in part, to the physical arrangement of the array, which may be limited in overall size by the size of the frame to which the individual sound detectors are mounted. Other embodiments may use other combinations of sound detectors and generate other directional responses.

FIG. 3 depicts a schematic diagram of another embodiment of a planar array 112 of sound detectors 116 for use in the listening arrangement 100 of FIG. 1. Compared with the illustrations of FIG. 1, the illustration of FIG. 3 depicts a top view of the listening arrangement 100 of FIG. 1.

In the depicted embodiment, the sound detectors 116 are coupled to a frame 118 which may be worn by the listener 102. One example of a frame 118 that may be worn by a user is shown in FIG. 5 and described in more detail below. Other embodiments may use other types of frames 118.

For convenience in describing one example of the operation of the planar array 112, four of the sound detectors 116 shown in the figure are black, while the remaining sound detectors are white. In one embodiment, the indicated (i.e., black) sound detectors 116 represent the subset of sound detectors 116 whose sound signals are used by the electronic circuitry to generate the reproduced sound signal. In one embodiment, the electronic circuitry is included in a hearing aid 120 coupled to the frame 118. The hearing aid 120 may be physically and/or electronically coupled to the frame 118. By processing the sound signals from the indicated subset of sound detectors 116, the electronic circuitry within the hearing aid 120 is able to form a beam pattern that provides the unity response 114 directed toward the sound generator 104, while directing a null toward the interference sound source 106. Other embodiments may use other combinations and/or numbers of sound detectors 116.

FIG. 4 depicts a schematic block diagram of one embodiment of an apparatus 130 for directional sound detection. The illustrated apparatus 130 includes a plurality of sound detectors (M) 116 (arranged in a planar array), an analog-to-digital converter (ADC) 132, a digital signal processor (DSP) 134, a digital-to-analog converter (DAC) 136, and an audio speaker 138. The illustrated apparatus 130 also includes a controller 140 and a power supply 142. Although the apparatus 130 is shown and described with certain components and functionality, other embodiments of the apparatus 130 may include fewer or more components to implement less or more functionality. For example, some embodiments of the apparatus 130 may have filters (not shown), a user interface (not shown), and so forth. For example, some embodiments include a user-control button or selector (e.g., integrated with the controller) for switching between end-fire and planar array operating modes. In this manner, a user could select the end-fire array operating mode for improved or optimal reduction of diffuse noise. Alternatively, the user could select the planar array operating mode for increased or optimal performance in the presence of diffuse noise and interference noise close to the intended sound generator 104.

In one embodiment, the analog-to-digital converter 132 converts one or more of the analog sound signals generated by the sound detectors 116 into corresponding digital signals. The digital signals also may be referred to as digital representations of the analog signals. Although a single analog-to-digital converter 132 is shown, other embodiments may include more than one analog-to-digital converter for faster processing of the sounds signals from the individual sound detectors 116.

The digital signal processor 134 receives the digital signals from the analog-to-digital converter 132 and generates the reproduced sound signal to be communicated to the listener 102. In one embodiment, the digital signal processor 134 processes the sound signals according to an algorithm or instructions from the controller 140. In this manner, the controller 140 may control a directivity angle of a superdirectional response based on the sound signals from the sound detectors 116. Further, in some embodiments, the controller 140 may include additional processing and/or memory resources. In other embodiments, the functionality of the controller 140 may be incorporated into the digital signal processor 134 or another component of the apparatus 130.

The digital signal processor 134 sends the digitally reproduced sound signal to the digital-to-analog converter 136, which converts the reproduced sound signal to an analog signal. The analog signal also may be referred to as an analog representation of the digitally reproduced sound signal. The digital-to-analog converter 136 then sends the analog signal to the audio speaker 138 which generates an audible sound representative of the reproduced sound signal. By listening to the audible sound from the speaker 138, the listener 102 is able to hear the sound generated by the sound generator 104, without significant interference from the interference sound source 106.

In one embodiment, the power supply 142 supplies power to the various components of the apparatus 130. In a specific example, the power supply 142 includes at least one battery and supplies a direct current (DC) power signal at a suitable voltage to the various components.

FIG. 5 depicts a diagram of one embodiment of a pair of hearing glasses 150 with a planar array of sound detectors 116 coupled to the frame of the hearing glasses 150. In general, the hearing glasses 150 may provide optical correction, similar to conventional eyeglasses, by way of two optical elements 152. The optical elements are conventionally mounted in a front portion 154 of the frame. Stems 156 on either side of the front portion 154 allow the user to wear the hearing glasses 150 and hold the frame in position relative to the user's head (not shown).

In the illustrated embodiment, several sound detectors 116 are schematically shown at various mounting locations on the front portion 154 and the stems 156 of the frame. More specifically, at least one sound detector 116 is coupled to the front portion 156 of the frame. Similarly, at least one sound detector 116 is coupled to one of the stems 156. Although the sound detectors 116 are shown in specific locations on the frame of the hearing glasses 150, other embodiments may include fewer or more sound detectors 116 mounted in similar or different locations on the frame.

Each of the sound detectors 116 is electronically coupled to the electronic circuitry 158 mounted to the left stem 156 of the hearing glasses 150. Electronic coupling may include physical connections via wires, wireless connections via radio frequency (RF) communications, of another similar type of coupling. In another embodiment, the electronic circuitry 158 may be mounted in a different location on the frame, or separated in multiple locations on the frame, or partially or wholly located at a remote location from the frame. As explained above, the electronic circuitry 158 generates the reproduced sound signal based on the sound signals from a planar array of sound detectors 116, including some (i.e., a subset) or all of the sound detectors 116. Together, the sound detectors 116, the electronic circuitry 158, and the audio speaker 138 make up one embodiment of a hearing aid device. In one embodiment, the audio speaker 138 is a personal audio speaker to generate the audible sound with sound wave characteristics that allow the audible sound to be heard primarily within the vicinity of a user's ear. Other embodiments may use other types of audio speakers or more than one audio speaker.

FIG. 6 depicts a flow chart diagram of one embodiment of a method 160 for controlling directivity of a hearing aid device. Although the method 160 is described in conjunction with the devices illustrated in the previous figures, embodiments of the method 160 may be implemented with other types of hearing aid devices.

At block 162, the hearing aid device detects sound waves at a plurality of sound detectors 116 coupled to a portable hearing aid device. As explained above, the sound detectors 116 are arranged in a planar array configuration. At block 164, the electronic circuitry 158 combines the sound signals from at least a subset of the sound detectors 116 to generate the reproduced sound signal. Depending on the amount of directivity that is desired or specified, the electronic circuitry 158 may combine the sound signals according to an algorithm or other instructions. At block 166, the electronic circuitry 158 generates an audible sound representative of the reproduced sound signal and, at block 168, communicates the audible sound to a user of the portable hearing aid device. In some embodiments, the operations of generating and communicating the audible signal may be combined, for example, where the audible signal is generated at a location that the user can hear the generated audible signal. The depicted method 160 then ends.

In further embodiments, the method 160 also may include additional operations which may be further beneficial to the operation of the portable hearing aid device. For example, in one embodiment, the method 160 also includes digitally combining the sound signals from at least three sound detectors and generating the reproduced sound signal based on a first-order steerable superdirectional response. In another embodiment, the method 160 also includes digitally combining the sound signals from at least four sound detectors and generating the reproduced sound signal based on a second-order steerable superdirectional response. In a further embodiment, digitally combining the sound signals from the sound detectors includes generating substantially a unity response at a listening angle toward the sound generator position, generating substantially a null response at an interference angle toward an interference sound position, and improving the directivity index (Q>1). For a first-order steerable superdirectional response, the planar array 112 can have an improvement of the directivity index even when suppressing an interference noise at an angle of approximately 45 degrees from the listening angle (e.g., β≧45°. In contrast, using a conventional line array arrangement to suppress an interference noise at this angle would result in a degradation of the directivity index (Q<1). Thus, the conventional line array is unable to maintain the directivity index while achieving good suppression of the interference noise. For a second-order steerable superdirectional response, the planar array 112 may exhibit an improvement even when suppressing an interference noise at an angle of approximately 30 degrees from the listening angle (e.g., β≧30°. In contrast, using a conventional line array arrangement to suppress an interference noise at this angle would result in a degradation of the directivity index (Q<1). Again, the conventional line array is unable to maintain the directivity index while achieving good suppression of the interference noise. In these examples, the improvement of the response may be approximately 2 dB. In other embodiments, the improvement of the response may be more or less. Additionally, the interference angle may be significantly smaller for both the first- and second-order steerable superdirectional responses. For example, the interference angle may be approximately 20, 15, 10, or even 5 degrees, although the diffuse response improvement may be significantly less as the interference angle decreases.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus for directional sound detection, the apparatus comprising:
a portable hearing aid device;
a plurality of sound detectors coupled to the portable hearing aid device, wherein the sound detectors are arranged in a substantially planar array which is located in approximately a two-dimensional plane which extends through both a listener position and a sound generator position; and
electronic circuitry electronically coupled to the plurality of sound detectors, wherein the electronic circuitry is configured to generate a reproduced sound signal based on sound signals from at least a subset of the plurality of sound detectors, wherein the subset comprises at least two sound detectors in a one-dimensional line and at least one sound detector located within the two-dimensional plane other than along the one-dimensional line.

2. The apparatus of claim 1, wherein the subset of the sound detectors comprises at least three sound detectors, and the electronic circuitry is configured to combine the sound signals to generate the reproduced sound signal based on a first-order steerable superdirectional response using the sound signals from the at least three sound detectors.

3. The apparatus of claim 1, wherein the subset of the sound detectors comprises at least four sound detectors, and the electronic circuitry is configured to combine the sound signals to generate the reproduced sound signal based on a second-order steerable superdirectional response using the sound signals from the at least four sound detectors.

4. The apparatus of claim 1, wherein the electronic circuitry is configured to combine the sound signals from the subset of the sound detectors to generate substantially a unity response at a listening angle toward the sound generator position.

5. The apparatus of claim 1, wherein the electronic circuitry is configured to combine the sound signals from the subset of the sound detectors to generate substantially a null response at an interference angle toward an interference sound position.

6. The apparatus of claim 1, further comprising an audio speaker coupled to the electronic circuitry, wherein the audio speaker is configured to generate an audible sound representative of the reproduced sound signal.

7. The apparatus of claim 1, wherein the electronic circuitry comprises a digital signal processor (DSP).

8. The apparatus of claim 7, wherein the electronic circuitry further comprises:
an analog-to-digital converter (ADC) coupled to the digital signal processor, wherein the analog-to-digital converter is configured to generate digital representations of the sound signals from the sound detectors; and
a digital-to-analog converter (DAC) coupled to the digital signal processor, wherein the digital-to-analog converter is configured to generate an analog representation of the reproduced sound signal.

9. The apparatus of claim 7, wherein the electronic circuitry comprises a controller to control a directivity angle of a superdirectional response based on the sound signals from the sound detectors.

10. A pair of hearing glasses comprising:
a pair of optical elements;
a frame comprising a front portion and two stems, wherein the front portion is configured to hold the pair of optical elements, and the stems are configured to hold the frame in a position relative to a user's head; and
a hearing aid device coupled to the frame, wherein the hearing aid device comprises:
a planar array of at least three sound detectors, wherein at least one sound detector is coupled to the front portion of the frame, and at least one sound detector is coupled to one of the stems; and
electronic circuitry electronically coupled to the planar array of sound detectors and configured to generate a reproduced sound signal based on sound signals from the planar array of sound detectors.

11. The pair of hearing glasses of claim 10, wherein the electronic circuitry is configured to combine the sound signals to generate the reproduced sound signal based on a first-order steerable superdirectional response using the at least three sound detectors.

12. The pair of hearing glasses of claim 10, wherein the planar array comprises at least four sound detectors, wherein the electronic circuitry is configured to combine the sound signals to generate the reproduced sound signal based on a second-order steerable superdirectional response using the at least four sound detectors.

13. The pair of hearing glasses of claim 10, wherein the electronic circuitry further comprises:
a digital signal processor (DSP) to digitally process the sound signals from the planar array of sound detectors to generate the reproduced sound signal; and
an audio speaker coupled to the digital signal processor, wherein the audio speaker is configured to generate an audible sound representative of the reproduced sound signal.

14. The pair of hearing glasses of claim 13, wherein the audio speaker comprises a personal audio speaker to generate the audible sound with sound wave characteristics that allow the audible sound to be heard primarily within the vicinity of a user's ear.

15. The pair of hearing glasses of claim 10, wherein the electronic circuitry further comprises a controller to control a directivity angle of a superdirectional response based on the sound signals from the sound detectors.

16. The pair of hearing glasses of claim 10, wherein the electronic circuitry further comprises a controller allow a user to select between one of a plurality of operating modes, wherein the operating modes comprise:
a planar array operating mode in which the electronic circuitry is configured to generate the reproduced sound signal based on sound signals from the planar array of sound detectors; and
a line array operating mode in which the electronic circuitry is configured to generate another reproduced sound signal based on sound signals from a line array of a plurality of sound detectors arranged in a line array configuration within the planar array.

17. The pair of hearing glasses of claim 10, wherein the electronic circuitry is configured to combine the sound signals from the planar array of sound detectors to generate substantially a unity response at a listening angle toward a position of a sound generator and to place substantially a null response at an interference angle toward a position of an interference sound source.

18. A method for controlling directivity of a hearing aid device, the method comprising:
detecting sound waves at a plurality of sound detectors coupled to a portable hearing aid device, wherein the sound detectors are arranged in a substantially planar array which is located in approximately a two-dimensional plane which extends through both a listener position and a sound generator position;
generating a reproduced sound signal based on sound signals from at least a subset of the plurality of sound detectors, wherein the subset comprises at least two sound detectors in a one-dimensional line and at least one sound detector located within the two-dimensional plane other than along the one-dimensional line; and
generating an audible sound representative of the reproduced sound signal and communicating the audible sound to a user of the portable hearing aid device.

19. The method of claim 18, further comprising:
digitally combining the sound signals from at least four sound detectors; and
generating the reproduced sound signal based on a second-order steerable superdirectional response using the combined sound signals from the at least four sound detectors.

20. The method of claim 19, wherein digitally combining the sound signals from the sound detectors further comprises:
generating substantially a unity response at a listening angle toward the sound generator position; and
generating substantially a null response at an interference angle toward an interference sound position, wherein the interference angle is at approximately 45 degrees from the listening angle for a first-order response and approximately 30 degrees from the listening angle for a second-order response.
